(19) United States
(12) Patent Application Publication
(10) Pub. No.: US 2004/0238562 A1
(43) Pub. Date: Dec. 2, 2004

(54) Beverage supply system mounting adapter

(76) Inventor: John H. Mathues, Evergreen, CO (US)

Correspondence Address: Merchant & Gould P.C., P.O. Box 2903, Minneapolis, MN, 55402-0903, US

(21) Appl. No.: 10/856,327

(22) Filed: May 28, 2004

Related U.S. Application Data
(63) Continuation-in-part of application No. 10/608,045, filed on Jun. 27, 2003.
Application No. 10/608,045 is a continuation-in-part of application No. 10/229,672, filed on Aug. 27, 2002, now Pat. No. 6,732,885.

(51) Int. Cl. B67D 5/08

(52) U.S. Cl. 222/52

(57) ABSTRACT

An embodiment of the present invention is a fitting for a mounting adapter of a beverage supply system. The fitting includes a base portion adapted to be secured to a body of the mounting adapter. A drain tube extends from the base portion to penetrate and seal the bottom opening of a beverage container. The drain tube further has a beverage outlet channel and an air inlet channel, each of the channels separately extending through the drain tube and the fitting. A sensor mounted on the beverage outlet channel near a base of the drain tube detects a beverage within the beverage outlet channel. A valve mounted on the beverage outlet channel closes the beverage outlet channel in response to the sensor detecting that no beverage is present in the beverage outlet channel.

### CROSS REFERENCE TO RELATED APPLICATIONS

This application is a continuation-in-part of U.S. Non-provisional patent application Ser. No. 10/608,045, filed Jun. 27, 2003 which is a continuation-in-part of U.S. Non-provisional patent application Ser. No. 10/227,672, filed Aug. 27, 2002.

### FIELD OF THE INVENTION

This application relates generally to bottled beverage supply systems and more particularly to a mounting adapter for a bottled beverage supply system that includes a valve to automatically close a beverage outlet channel when a beverage container becomes empty.

### BACKGROUND OF THE INVENTION

Due to high levels of impurities found in many domestic water supplies, a substantial number of households and offices prefer not to use their domestic water supplies as a source of drinking water, when making ice, or when making coffee or the like. As a consequence, such households frequently purchase bottled water for such uses. While there are numerous devices for dispensing bottled water and other bottled beverages for drinking purposes, it is considerably more difficult to supply bottled water to the icemaker or chilled water dispenser of a refrigerator. Typically, a water supply line for a refrigerator is connected directly to the domestic water supply, perhaps with a filter installed between them. Thus, if bottled water is to be supplied to a refrigerator, it should be supplied under a pressure comparable to that of the domestic water supply system.

Prior devices for supplying pressurized bottled water to a refrigerator or other water dispenser have not proven to be commercially viable. For example, some such systems have often required activation of a pump each time water is supplied to the dispenser. Thus, each time a user gets water from a refrigerator or otherwise uses the water supply, the pump is activated. This is both an annoyance to the user and a waste of energy. Other systems have required the use of a dip leg and its attendant inefficiencies, such as wasted water.

Additionally, when used to supply water to an icemaker or to supply water or other beverage for consumption, it is important to keep the beverage supply system as clean as possible to limit the growth of mold and bacteria. Common gravity fed or pump fed beverage supply systems do not seal the supply system to reduce the introduction of contaminants.

Accordingly there is a need for a reliable, clean and convenient system for supplying water or other beverages from a bottle to a dispenser, such as a refrigerator. The present invention provides a solution to this and other problems, and offers other advantages over the prior art.

### SUMMARY OF THE INVENTION

Against this backdrop the present invention has been developed. An embodiment of the present invention is a beverage supply system mounting adapter. The mounting adapter includes a funnel-shaped body defining an opening at a base of the body and an opening at a top of the body that is wider than the opening at the base of the body. The funnel-shaped body is adapted to receive a beverage container having a bottom opening. The mounting adapter also includes a fitting mounted in the opening at the base of the body. The fitting has a drain tube extending upwards into the body of the mounting adapter to penetrate and seal the bottom opening of the beverage container. The drain tube further has a beverage outlet channel and an air inlet channel, each of the channels separately extending through the drain tube and the fitting. The mounting adapter also includes a sensor mounted on the beverage outlet channel near a base of the drain tube to detect a beverage within the beverage outlet channel. A valve mounted on the beverage outlet channel closes the beverage outlet channel in response to the sensor detecting that no beverage is present in the beverage outlet channel.

Stated yet another way, an embodiment of the present invention is a fitting for a mounting adapter of a beverage supply system. The fitting includes a base portion adapted to be secured to a body of the mounting adapter. A drain tube extends from the base portion to penetrate and seal the bottom opening of a beverage container. The drain tube further has a beverage outlet channel and an air inlet channel, each of the channels separately extending through the drain tube and the fitting. A sensor mounted on the beverage outlet channel near a base of the drain tube detects a beverage within the beverage outlet channel. A valve mounted on the beverage outlet channel closes the beverage outlet channel in response to the sensor detecting that no beverage is present in the beverage outlet channel.

These and various other features as well as advantages which characterize the present invention will be apparent from a reading of the following detailed description and a review of the associated drawings.

### BRIEF DESCRIPTION OF THE DRAWINGS

FIG. 1 is a schematic diagram of the beverage supply system according to an embodiment of the present invention.

FIG. 2 is a front perspective view of a beverage supply system according to an embodiment of the present invention.

FIG. 3 is a rear perspective view of the beverage supply system of FIG. 2 with its access door removed.

FIG. 4 is a front separate perspective view of the support frame, the second reservoir, and the pump of the beverage supply system of FIG. 2.

FIG. 5 is a sectional view taken along line 5-5 of FIG. 2.

FIG. 6 is a separate sectional view of the second reservoir of the beverage supply system of FIG. 2 with the beverage chamber empty.

FIG. 7 is a separate sectional view similar to FIG. 6, but with the beverage chamber being partially filled.

FIG. 8 is a separate sectional view similar to FIG. 7, but with the beverage chamber being more full than in FIG. 7.

FIG. 9 is vertical sectional view of a beverage supply system in accordance with an alternative embodiment of the present invention.

FIG. 10 is a schematic diagram of the alternative beverage supply system according to the present invention shown in FIG. 9.

FIG. 11 is a rear perspective view of the alternative beverage supply system of FIG. 9 with its access door removed.

FIG. 12 is a top perspective view of a mounting adapter for a beverage supply system according to one embodiment of the present invention.

FIG. 13 is a bottom perspective view of the mounting adapter for a beverage supply system illustrated in FIG. 12.

FIG. 14 is a top view of the mounting adapter for a beverage supply system illustrated in FIG. 12.

FIG. 15 is a side view of a fitting for a mounting adapter of a beverage supply system according to one embodiment of the present invention with portions shown in phantom.

FIG. 16 is a bottom perspective view of the fitting for a mounting adapter of a beverage supply system illustrated in FIG. 15.

### DETAILED DESCRIPTION

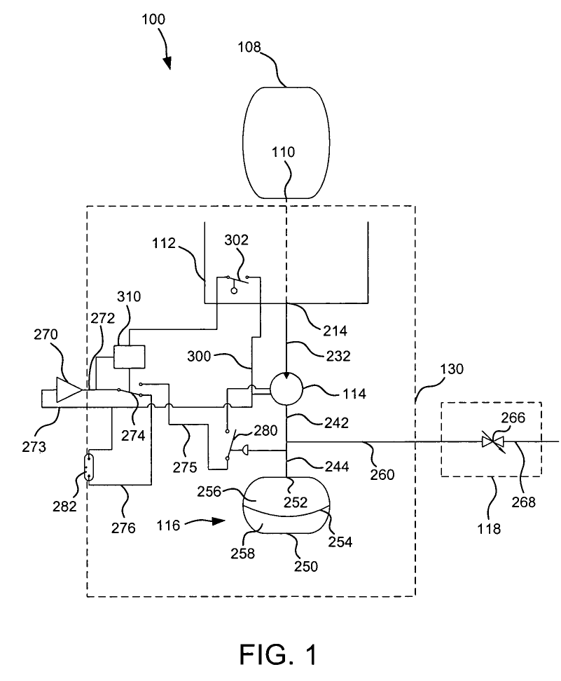

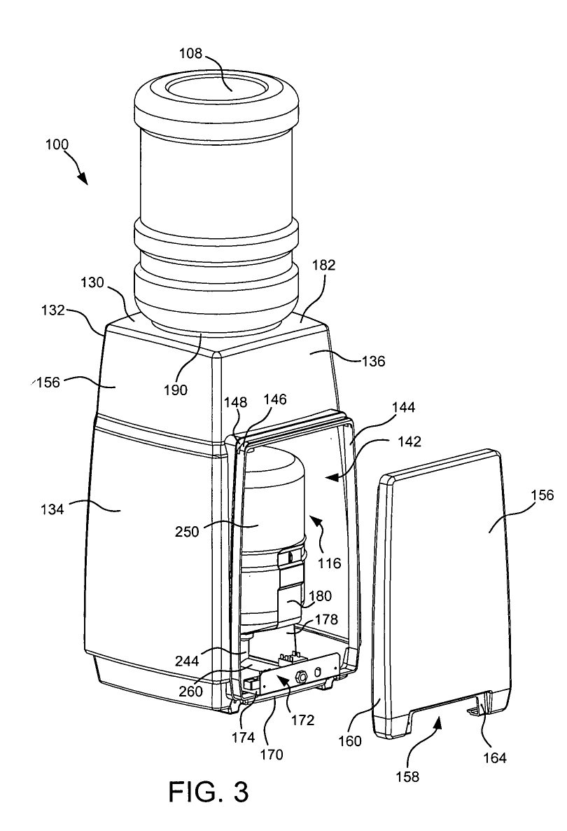

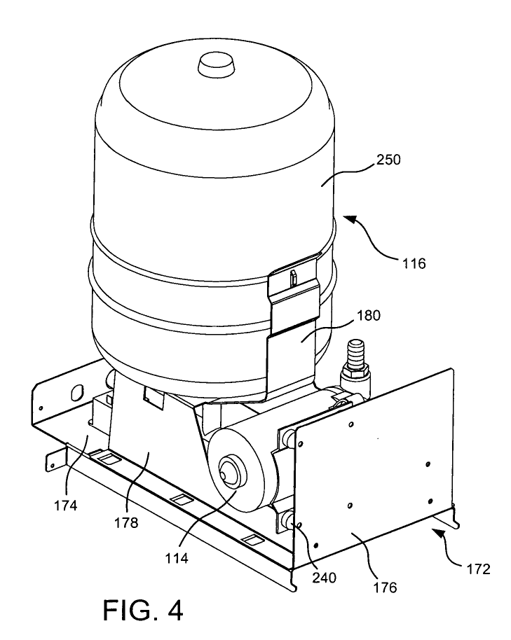

Referring to FIGS. 1-5, a bottled beverage supply system 100 generally includes a beverage bottle or container 108, such as a conventional water bottle, having an outlet 110 that feeds into a first reservoir 112. A pump 114 pumps beverage from the first reservoir 112 to a pressurized second reservoir 116. The beverage is then supplied from the second reservoir 116 to a beverage dispenser 118. Because the second reservoir 116 is pressurized, beverage can be supplied from the second reservoir 116 to the beverage dispenser 118 without operating the pump 114. The pump 114 only needs to be activated when the quantity of beverage in the second reservoir 116 becomes too low. Thus, the bottled beverage supply system 100 preferably supplies pressurized beverage to the beverage dispenser 118 in an efficient manner without requiring the pump 114 to be constantly operated while beverage is being supplied to the beverage dispenser 118.

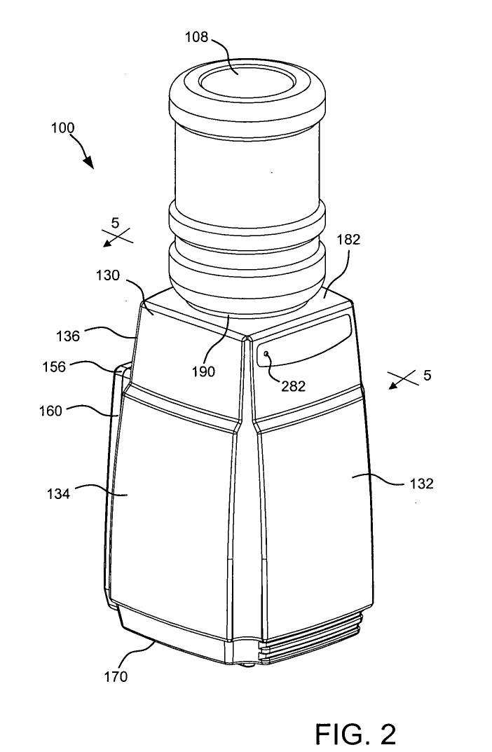

Referring still to FIGS. 2-3 and 5, and describing the bottled beverage supply system 100 in more detail, a housing 130 has a substantially rectangular front wall 132, a pair of substantially rectangular side walls 134 extending back from opposite side edges of the front wall 132, and a substantially rectangular rear wall 136 extending between the rear edges of the side walls 134. A substantially rectangular door opening 142 in the rear wall 136 provides access to the interior space of the housing 130. A housing collar 144 extending about the periphery of the door opening 142 protrudes rearward, and a lip 146 extends up from the rear edge of the top of the housing collar 144 to define a channel 148 between the lip 146 and the rear wall 136. A substantially rectangular door 156 spans the door opening 142, but includes a cutout 158 from its bottom edge to provide limited access to the interior space of the housing 130 while the door is mounted on the housing 130. The door 156 also includes a door collar 160 extending forward from the periphery of the door 156 and a lip 162 extending down from the front edge of the top of the door collar 160. The door collar 160 fits around the housing collar 144, and the door lip 162 extends down into the channel 148 so that the door lip and the housing lip 146 interlock. The door 156 also includes fastener holes 164 near its bottom edge to facilitate fastening the bottom of the door 156 in place.

A floor 170 of the housing 130 joins the bottom edges of the front wall 132, the side walls 134, and the rear wall 136 to form a bottom closure of the housing 130. A support frame 172 is securely mounted on the floor 170 within the housing 130. The support frame 172 includes a horizontal base 174, a front wall 176 extending up from the front edge of the base 174, and a reservoir pedestal 178 rising above the base 174. A pair of reservoir support arms 180 extend up from front and rear sides of the reservoir pedestal 178 on opposite sides of the second reservoir 116.

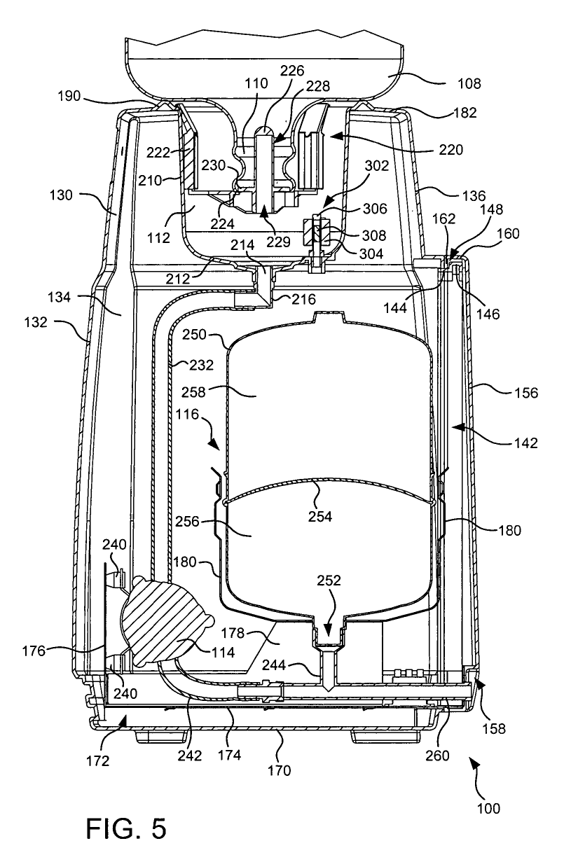

A top wall 182 of the housing 130 joins the top edges of the front wall 132, the side walls 134, and the rear wall 136. A centrally located annular ridge 190 preferably protrudes upwardly from the top wall 182 and supports the body of the beverage bottle 108. Referring to FIG. 5, the first reservoir 112 includes an annular side wall 210 that depends from the top wall 182 inside the annular ridge 190. A sloped wall 212 slopes downward and inward from the side wall 210 to an outlet 214. The outlet 214 preferably empties into a fitting 216.

A drain apparatus 220 includes a support structure 222 that extends from the top wall 182 of the housing 130 down and into the first reservoir 112. The support structure 222 supports a mating surface 224 that preferably abuts the rim of the downwardly facing outlet 110 of the bottle 108. The support structure 222 is also preferably positioned and oriented to act as a guide to guide the outlet 110 toward the mating surface 224 when the bottle 108 is positioned on the beverage supply system 100. A drain tube 226 also supported by the support structure 222 preferably extends up into the outlet 110. The drain tube 226 includes top openings 228 at its upward end and a bottom opening 229 at its lower end. A drain tube flange 230 extends outwardly from the drain tube 226 and preferably seals with the mating surface 224. Water is thus supplied to the first reservoir 112 through the drain tube 226 until the level of beverage in the first reservoir rises to the bottom opening 229 and prevents air from entering the drain tube 226.

The housing 130, the first reservoir 112, the support structure 222 are all preferably part of a unitary member. The unitary member is preferably formed of structural polymer material such as a thermoplastic material. The unitary member can be formed by a roto-mold process. Alternatively, the body could be formed as separate members that are joined together. In this case, the body could be formed by a blow mold process.

A pump supply line 232 extends from the fitting 216 to the pump 114. The pump 114 is preferably a positively displaced pump that can produce at least about 100 pounds per square inch of pressure. Alternatively, the pump could be some other type of pump in combination with a check valve to prevent backflow through the pump when the pump is not operated. Pump mounts 240 that are preferably arranged to prevent the transmission of vibrations between the pump 114 and the front wall 176 preferably mount the pump to the front wall 176 of the support frame 172.

A pump exit line 242 extends from an outlet of the pump 114 to a second reservoir line 244. The second reservoir line 244 extends to the second reservoir 116. The second reservoir 116 preferably includes a pressure tank 250 having an inlet and outlet opening 252 attached to the second reservoir line 244. A solid barrier or diaphragm 254 is preferably a thin flexible member that is secured to the sides of the pressure tank 250 and divides the pressure tank 250 into a beverage chamber 256 that opens into the opening 252, and a gas chamber 258 that is filled with a pressurized gas such as air.

Referring to FIG. 1, a dispenser supply line 260 extends from the second reservoir line 244 to the dispenser 118. The dispenser 118 preferably includes a dispenser valve 266 attached to the dispenser supply line 260 and a dispenser exit line 268. The dispenser exit line may be connected to a spigot, an icemaker, or any other device for supplying beverage in liquid or solid form to users.

The various beverage supply lines may be constructed of any suitable material, but they are preferably standard polyethylene tubing such as is often used in supplying drinking water to refrigerators or other beverage dispensers.

A power supply 270 preferably supplies alternating current electrical power, such as from a standard 120-volt outlet. A power switch power line 272 and a constant supply power line 273 are both connected to the power supply 270, with each power line 272, 273 at a different voltage. Accordingly, the power supply 270 will supply power to electrical components that are connected to both the power switch power line 272 and the constant supply power line 273. The power switch power line 272 is connected to a power switch 274, which switches between one position that connects the power switch power line 272 to a pressure switch power line 275 and another position that connects the power switch power line 272 to an indicator power line 276.

The pressure switch power line 275 extends to the pump 114 via a pressure switch 280 that is pneumatically connected to the beverage chamber 256 of the second reservoir 116 via the second reservoir line 244. The pressure switch 280 preferably closes when the pressure within the beverage chamber 256 drops below a pressure range, and preferably reopens when the pressure within the beverage chamber 256 rises above the pressure range. The pressure range is preferably within the required pressure range for the dispenser 118. The pressure range preferably has a lower limit of from about thirty-five to about forty-five psi, and an upper limit of from about sixty to about seventy psi. In a preferred embodiment, the lower limit of the pressure range is about forty psi and the upper limit is about sixty-five psi so that the pressure range is from about forty psi to about sixty psi. Accordingly, in a preferred embodiment, the pressure switch 280 closes when the pressure within the beverage chamber 256 drops below forty psi, opens when the pressure within the beverage chamber 256 rises above sixty-five psi, and does not switch when the pressure within the beverage chamber 256 is within the pressure range between forty and sixty-five psi.

The pump 114 is constantly connected to the constant supply power line 273. Thus, when the power switch 274 connects the power switch power line 272 to the pressure switch power line 275, and the pressure switch 280 is closed, then the power supply 270 supplies power to the pump 114 and thereby activates the pump 114 to pump beverage from the first reservoir 112 to the second reservoir 116.

The indicator power line 276 extends to an indicator light 282 that is preferably viewable by a user of the beverage supply system 100. The indicator light 282 is also constantly connected to the constant supply power line 273 so that when the power switch 274 connects the power switch power line 272 to the indicator power line 276, then the indicator light 282 receives power from the power supply 270 and is illuminated.

A fluid level switch power line 300 extends from the constant supply power line 273 to a fluid level switch 302. The fluid level switch 302 is preferably driven by the fluid height of the beverage within the first reservoir 112. Preferably, if sufficient beverage is within the first reservoir 112 to be pumped into the second reservoir 116, then the fluid level switch 302 closes. Referring to FIG. 5, the fluid level switch preferably includes an annular float 304 that extends about a sealed cylinder 306 so that the float 304 is able to slide up and down on the sealed cylinder 306 as the beverage level within the first reservoir 112 rises and falls. A follower 308 positioned within the sealed cylinder 306 is magnetically attracted to the float 304 so that the follower 308 moves up and down with the float 304 to actuate the fluid level switch 302.

Referring back to FIG. 1, the fluid switch power line 300 extends from the fluid level switch 302 to a relay 310 that actuates the power switch 274. The relay 310 is preferably constantly connected to the power switch power line 272 so that the relay 310 receives power from the power supply 270 when the fluid level switch 302 is closed. Preferably, if the fluid level switch 302 is closed, indicating the fluid level within the first reservoir 112 is sufficiently high, and then the relay 310 switches the power switch 274 to connect the power switch power line 272 to the pressure switch power line 275. If the fluid level switch 302 is open, then the relay 310 switches the power switch 274 to connect the power switch power line 272 to the indicator power line 276, rather than the pressure switch power line 275.

Thus, the power supply 270 will begin to supply power to activate the pump 114 if: (1) the pressure switch 280 is closed, indicating the pressure of the beverage within the second reservoir 116 is below the operating pressure range, which in turn indicates that the quantity of beverage within the second reservoir 116 is below an operating range; and (2) the fluid level switch 302 is closed, indicating the first reservoir 112 contains sufficient beverage to be supplied by the pump 114 to the second reservoir 116. The power supply 270 will cease supplying power to deactivate the pump 114 if either: (1) the pressure switch 280 opens, indicating the pressure of the beverage within the second reservoir 116 is above the operating pressure range; or (2) the fluid level switch 302 opens, indicating that the beverage level within the first reservoir 112 is not sufficiently high to continue supplying beverage to the second reservoir 116.

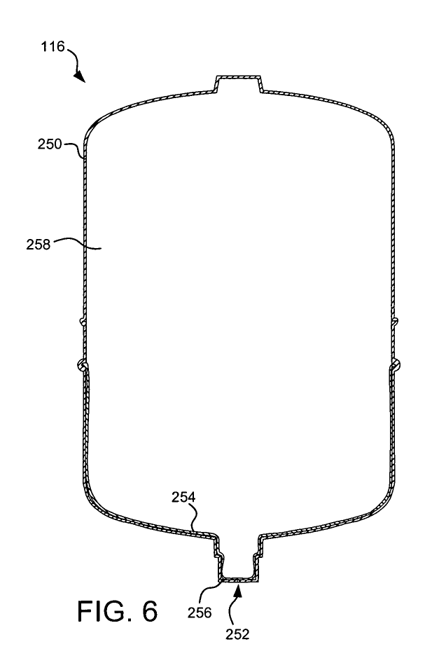

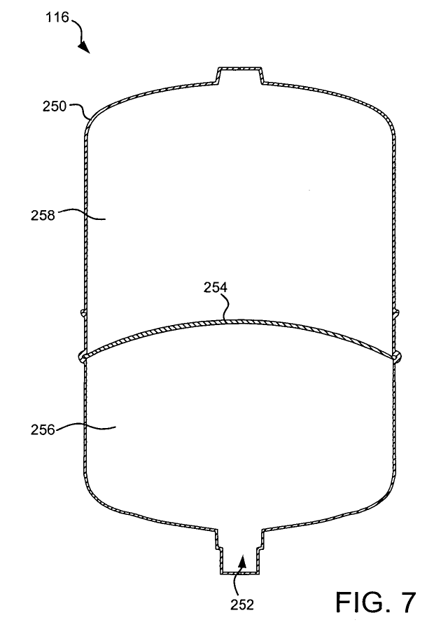

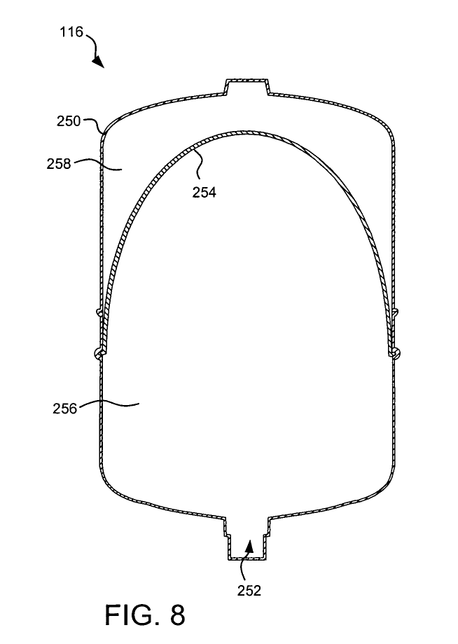

In operation, the bottle 108 is placed in the inverted position shown in FIGS. 2-5. Referring to FIG. 1, at that time, beverage will fill the first reservoir 112, as discussed above. This filled status is indicated to the relay 310 by the fluid level switch 302 as described above, and the relay will switch the power switch 274 to connect the power switch power line 272 to the pressure switch power line 275. The second reservoir 116 may initially contain no beverage, so that the gas within the gas chamber 258 presses the barrier 254 against the sides and bottom of the tank so that the beverage chamber 256 has substantially no volume as shown in FIG. 6. In this state where the second reservoir 116 has no beverage or if its beverage level is low then its pressure is also low. This low beverage quantity and pressure status is indicated by the pressure switch 280 closing, and thereby connecting the pump 114 to the power switch power line 272 via the pressure switch power line 275 and the power switch 274. The pump 114 is thereby operated to pump beverage from the first reservoir 112 to the beverage chamber 256 of the second reservoir 116. As the pump 114 increases the quantity of beverage in the beverage chamber 256, the pressure in the beverage chamber 256 also increases. The pressure of the beverage presses against and displaces the barrier 254 so that the beverage chamber 256 expands to accommodate the increasing quantity of beverage as shown in FIGS. 7-8. The pump 114 continues pumping beverage from the first reservoir 112 to the beverage chamber 256 of the second reservoir 116 until the pressure within the beverage chamber rises above the operating pressure range. At that point, the pressure switch 280 opens, thereby disconnecting the pump 114 from the power switch power line 272 and deactivating the pump.

Because the dispenser 118 is connected to the pressurized beverage chamber 256, pressurized beverage is supplied to the dispenser 118. The beverage may be automatically or manually dispensed from the dispenser 118 by opening the dispenser valve 266. As the beverage is dispensed from the dispenser 118, the quantity of beverage within the beverage chamber 256 decreases. The pressure within the beverage chamber 256 also decreases and the barrier 254 contracts the beverage chamber 256. This contraction may continue during several uses of the dispenser 118 without the pump 114 being operated. Thus, users of the dispenser 118 are not annoyed by the constant noise of the pump 114 as they use the dispenser 118, making use of the dispenser 118 a more pleasant experience.

When the pressure within the beverage chamber 256 of the second reservoir 116 drops below the operating range, then the pressure switch 280 closes again. This will again operate the pump 114 so long as sufficient beverage remains within the first reservoir 112 as indicated by the fluid level switch 302 being closed. This cycle of beverage being supplied from the expandable beverage chamber 256 and the pump 114 operating periodically to supply beverage to the beverage chamber 256 continues so long as the first reservoir 112 contains sufficient beverage. When the beverage supply system 100 has emptied the bottle 108, the bottle will, of course, no longer supply beverage to the first reservoir 112, and the beverage level of the first reservoir 112 will drop until the first reservoir no longer contains sufficient beverage to be pumped to the beverage chamber 256 of the second reservoir. At that time, the float 304 of the fluid level switch 302 will also drop, and the fluid level switch 302 will open. The relay 310 will then switch the power switch 274 from the pressure switch power line 275 to the indicator power line 276. With the pressure switch power line 275 disconnected from the power switch power line 272, the pump 114 can no longer be operated, even if the pressure switch 280 is closed. With the indicator power line 276 connected to the power switch power line 272, the indicator light 282 will remain on so long as the fluid level within the first reservoir 112 remains low. The indicator light 282 thereby indicates that the bottle 108 is empty and needs to be replaced with a new bottle. When the bottle 108 is replaced, then operation of the beverage supply system 100 continues as described above.

If the beverage supply system 100 needs to be disconnected from the dispenser 118, the bottle 108 can be removed. The beverage within the system 100 can then be drained by simply opening the dispenser valve 266. The dispenser 118 can then be disconnected. Alternatively, a valve could be included on the dispenser supply line 260. This valve could be closed before disconnecting the dispenser 118.

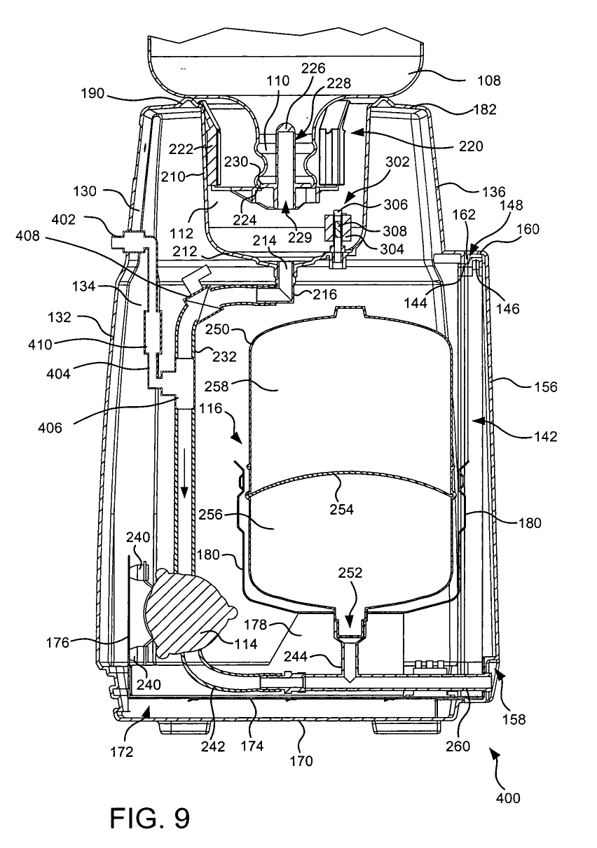

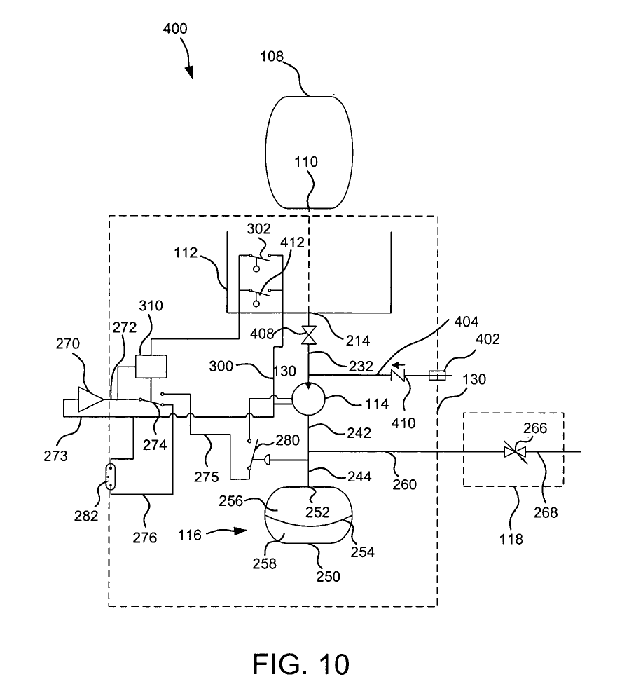

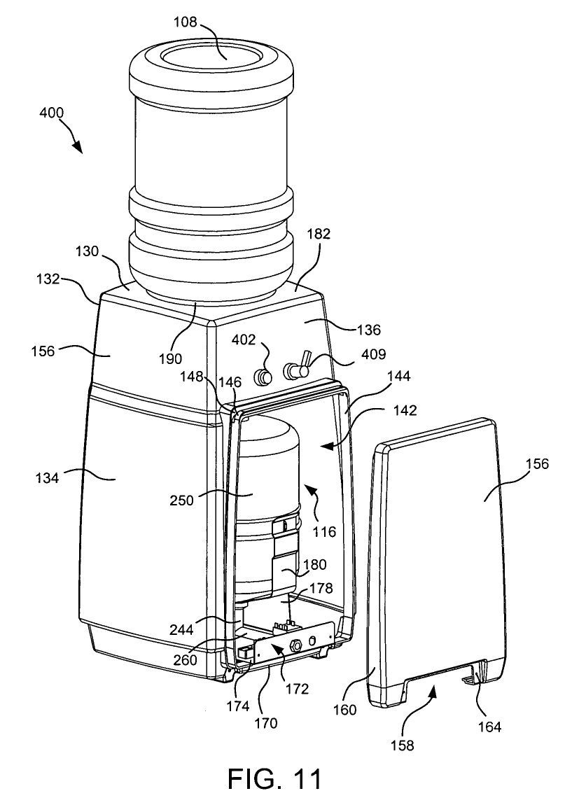

An alternative embodiment 400 of the beverage supply system in accordance with the present invention is shown in FIGS. 9, 10 and 11. A schematic diagram is shown in FIG. 10. A sectional view is shown in FIG. 9, and a perspective view of the system 400 is shown in FIG. 11. In this alternative embodiment, the system 400 is designed to accommodate an external source of beverage supply in addition to a bottle supply as in beverage supply system 100. The components and operation of the system 400 are the same as in system 100 described in detail above except for the addition of a provision for connection of the system to a feed from an external source, such as a reverse osmosis water purification system (not shown) through a port 402 that passes through the wall 132 to a line 404 which connects to a tee fitting 406 in the feed line 232 to the pump 114, and the provision of a switch contact 412 to bypass the float switch 302 as described below.

In FIGS. 9, 10, and 11, the same numbering of components is utilized as in the first embodiment 100 described above except for the additional components added. In particular, a valve 408 is placed between the outlet fitting 216 and the tee 406 in the line 232. This valve 408 remains open whenever the system 400 is operated as described with reference to system 100. This valve 408 is preferably a solenoid valve, with a hand switch operator handle 409 on the outside of the cabinet, as is shown in FIG. 11, although it may alternatively be a manual valve as well. In this alternative embodiment 400, the bottle water source preferably may be utilized only if the external system is unavailable. This might be desirable, for example, in a commercial environment or a home environment where the water needs are greater than can be economically handled with single bottles. In such situations, a reverse osmosis water purification system might be in place. The output of this external system is provided as an input to system 400 via port 402. Beverage passes through the port 402, through line 404, tee 406, and into the pump 114 as needed. Should the external system be taken off line for any reason, a water bottle 108 would be installed, solenoid valve 408 opened via switch 409, and the system 400 operated as above described with reference to system 100. A solenoid stop/check valve 410 in the feed line 404 prevents backflow of bottle water through the port 402 into the external system. In actual operation, the external system may predominate in supplying the beverage to the pump 114, while a bottle 108 is installed and simply provides either an automatic backup source for the system 400 if valve 408 is chosen appropriately as a solenoid operated stop/check valve, or manual backup source for the system 400 if valve 408 is a hand valve.

In the case where a bottle 108 is not installed in the first reservoir 112 during normal operation, a circular cap would be installed over the opening into reservoir 112 that engages the annular ridge 190 in the top wall 182. When it is desired to install a bottle 108, the cap would simply be removed and stored inside the housing of the system 400.

Referring now to FIG. 10, a perspective view is shown. Note that valve 408 has a handle 409 protruding through the cabinet front. This handle is the solenoid operator for valve 408. In operation, the valve 408 not only closes off the first reservoir 112 while the external system is supplying beverage to the second reservoir through the pump 114, the control for this valve, the handle 409 on the front of the unit, has a switch contact 412 that bypasses the float switch 302 so that when a bottle 108 is not installed, the pump 114 will continue to operate as previously described to provide beverage through the external supply to the second chamber 256 being maintained within the desired pressure range.

A beverage supply system such as described above or another type of system, such as a gravity fed system, may utilize a mounting adapter to hold or support a water bottle or container such as container 108. The mounting adapter may be located in various positions in or on the beverage supply system. For example, the mounting adapter may be located on top of a housing, such as housing 130 above, such that a container may be easily placed on top of the beverage supply system. In some cases, the mounting adapter may be separate from the housing or molded as an integral part of the housing. Alternatively, the mounting adapter may be located inside of the beverage supply system behind a door, drawer, access panel, etc.

Regardless of the exact location, the mounting adapter is configured to accept a beverage container such as a typical water bottle having a spout or neck portion that is sealed with a cap. The mounting adapter penetrates and seals the cap when the container is installed on the beverage supply system. The mounting adapter is coupled with the rest of the beverage supply system via hoses, tubing, or other means. In this way, a beverage within the container may be withdrawn and dispensed by the beverage supply system.

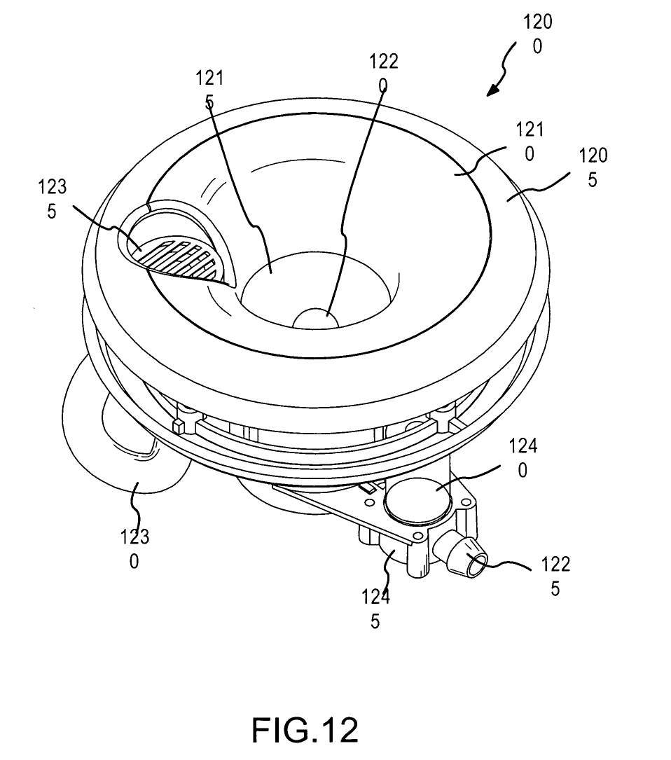

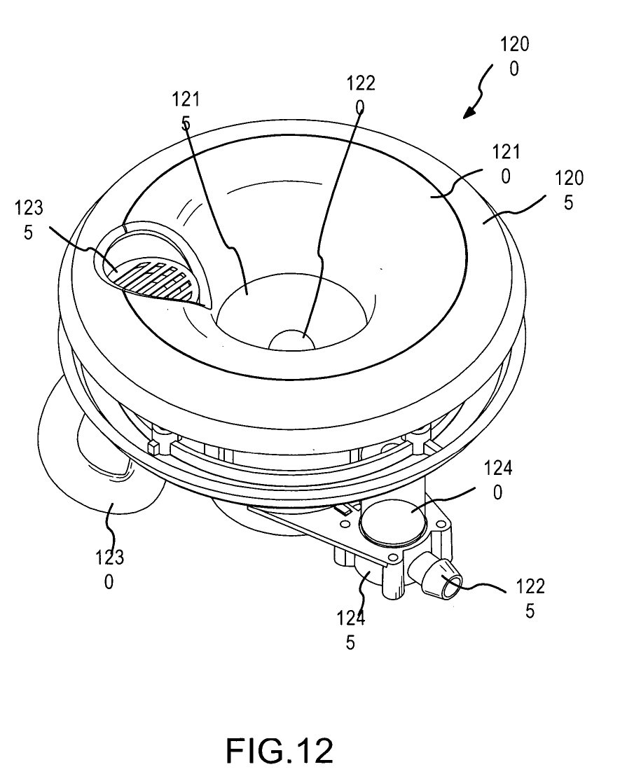

FIG. 12 is a top perspective view of a mounting adapter for a beverage supply system according to one embodiment of the present invention. Here, a mounting adapter 1200, such as may be used in a beverage supply system as described above or with another type of system that utilizes bottled beverages, is shown. The mounting adapter includes a funnel-shaped body 1205 with an opening at a base of the body 1215 and an opening at a top of the body 1210 that is wider than the opening at the base of the body. In this way, the body 1210 of the mounting adapter 1200 is adapted to receive a beverage container having a bottom opening such as a spout or neck common on water bottles or similar containers. Of course, the exact configuration of the funnel-shaped body may vary depending on the type of container used with the beverage supply system.

A fitting (not shown in this view) is mounted in the opening at the base of the body. The fitting has a drain tube 1220 extending upwards into the body 1205 of the mounting adapter 1200. When a beverage container is placed on the mounting adapter 1200, the drain tube 1220 penetrates and seals the bottom opening of the beverage container. The drain tube 1220 has a beverage outlet channel and an air inlet channel, each of the channels separately extending through the drain tube 1220 and the fitting. Via these channels, beverage may be drained from the container and replaced with air. The mounting adapter 1200 may also include an air filter 1235. The air filter 1235 may be mounted in an opening in the body 1210 or in another convenient location. The air filter 1235 may then be connected with the air inlet channel of the drain tube via an air line 1230 such as a flexible tubing.

A valve 1245 mounted on the beverage outlet channel can be used to open and close the beverage outlet channel as appropriate. In some cases, the valve may be operated by a solenoid 1240 or other type of actuator. According to one embodiment, a sensor (not shown in this view) mounted on the beverage outlet channel near the base of the drain tube may be used to detect beverage within the beverage outlet channel. Further, a signal from the sensor may be used to close the beverage outlet channel by closing the valve 1245 in response to the sensor detecting that no beverage is present in the beverage outlet channel. In this way, the beverage outlet channel may be closed once the beverage container has been drained in order to prevent contaminants from entering the beverage outlet channel.

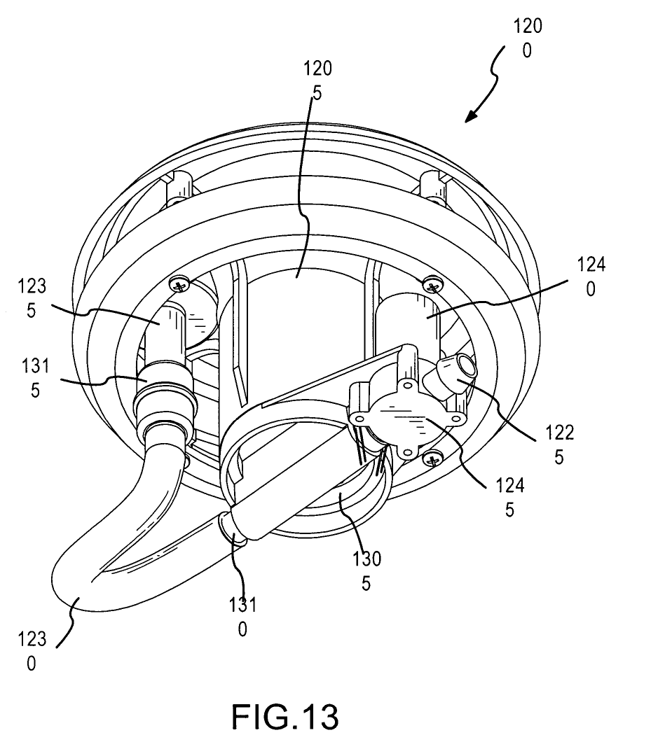

FIG. 13 is a bottom perspective view of the mounting adapter for a beverage supply system illustrated in FIG. 12. In this view, a fitting 1305 can be seen mounted in the bottom opening of the body 1205 of the mounting adapter 1200. In some cases, the fitting 1305 may be secured to the body 1205 of the mounting adapter 1200 via threads on the fitting 1305 and the inside of the opening at the bottom of the body 1205 of the mounting adapter 1200. The fitting 1305 provides a beverage outlet coupling 1225 and an air inlet coupling 1310 through which connections may be made to the beverage outlet channel and air inlet channel. These channels run through the fitting 1305 and drain tube (not visible here) which extends from the fitting 1305 inside the body 1205 of the mounting adapter 1200.

Also visible in this view is the air filter 1235 mounted in a hole in the body 1205 of the mounting adapter 1200. A check valve 1315 may also be coupled with the air filter and the air inlet channel via the air line 1230 connected with the air inlet coupling 1310. In this way, the check valve 1315 seals the air inlet channel and prevents beverage in a container mounted on the mounting adapter 1200 from flowing out of the air filter 1235 unless the vacuum inside the container is sufficient to draw air through the check valve 1315 and air inlet channel.

This view also shows the valve 1245 with the solenoid actuator 1240 coupled with the fitting 1305. As in this example, the valve 1245 may be positioned close to the body of the mounting adapter in order to reduce the length of the beverage outlet channel and therefore reduce the amount of air introduced into the beverage outlet chamber when the container is emptied. Additionally, the fitting 1305 and the body of the valve 1245 may be molded as a single piece. Alternatively, the valve may be mounted elsewhere and connected with the fitting via tubing or other plumbing. On the downstream side of the valve 1245 a beverage outlet coupling 1225 is connected with the valve to provide a means of connecting the mounting adapter 1200 to a beverage supply system.

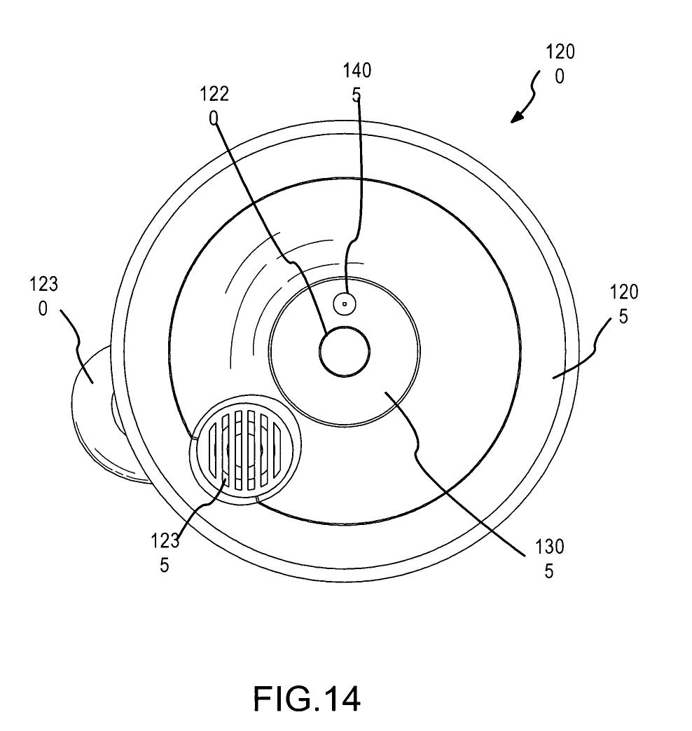

FIG. 14 is a top view of the mounting adapter for a beverage supply system illustrated in FIG. 12. Here, the mounting adapter is shown including the drain tube 1220 and fitting 1305 mounted in the body 1205 of the mounting adapter 1200. Also shown in this view is an air filter 1235 mounted in a hole in the body 1205 of the mounting adapter 1200. Additionally, this view shows a funnel drain 1405 in the fitting 1305. This drain 1405 may be connected directly, or via tubing, to a drip pan or other drain external to the beverage supply system. This drain 1405 allows the draining of beverage that leaks from the container during installation or as the result of holes or cracks in the container. This way, leaked beverage does not accumulate in the body 1205 of the mounting adapter 1200 which reduces the transfer of harmful bacteria and mold from bottle to bottle when replenishing the system.

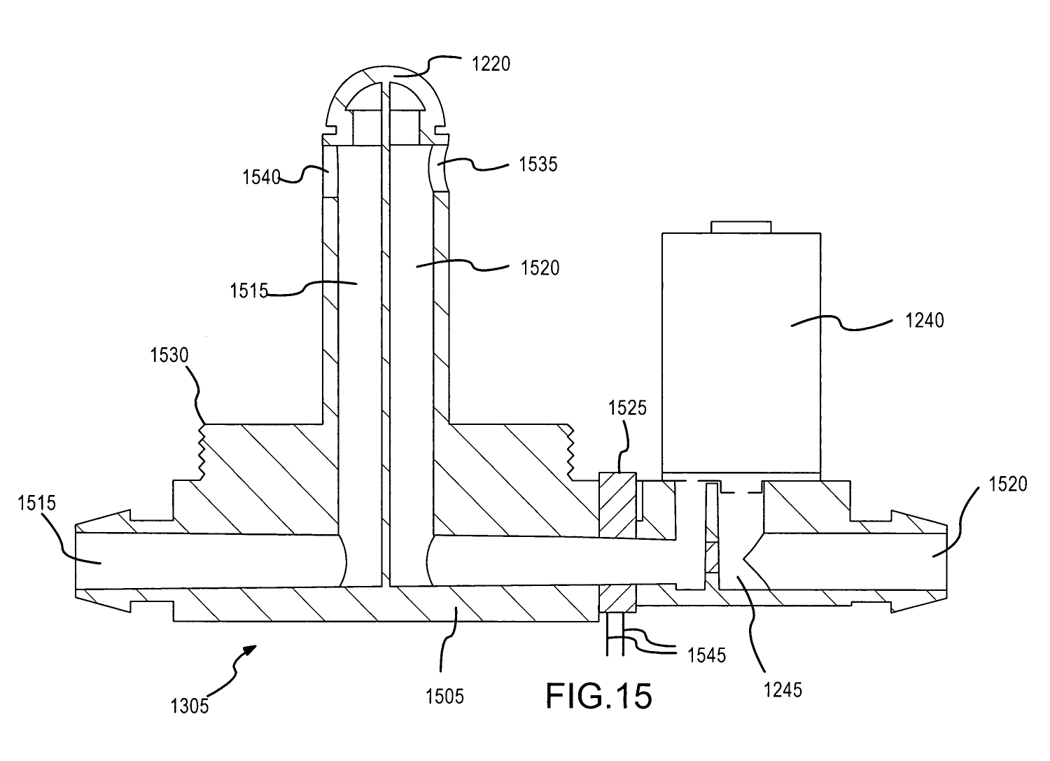

FIG. 15 is a side view of a fitting for a mounting adapter of a beverage supply system according to one embodiment of the present invention with portions shown in phantom. In this example, the fitting 1305 includes a base portion 1505 adapted to be secured to a body of the mounting adapter. In this case, the base portion 1505 includes threads 1530 to mate with matching threads in the bottom opening of the body of the mounting adapter. Alternatively, the fitting may be secured to the body of the mounting adapter by other means such as screws, bolts, clamps, adhesives, or other means. The drain tube 1220 extends from the base portion 1505 to penetrate and seal the bottom opening of the beverage container when the container is placed on the mounting adapter. The drain tube 1220 further includes a beverage outlet channel 1520 and an air inlet channel 1515. Each of the channels 1515 and 1520 separately extend through the drain tube 1220 and the base portion 1505 of the fitting 1305.

While shown here as being substantially horizontal or perpendicular to the drain tube 1220, the portion of the beverage outlet channel 1520 that runs through the base portion 1505 of the fitting 1305 may be disposed at a different angle relative to the drain tube 1220. For example, in some cases, the portion of the beverage outlet channel 1520 that runs through the base portion 1505 of the fitting 1305 may be angled downwards, that is, at an angle of greater than ninety degrees relative to the drain tube 1220, in order to allow air that enters the beverage outlet channel 1520 when the container is empty to escape when the container is replaced or refilled.

The valve 1245 is located in the beverage outlet channel 1520 to open or close the beverage outlet channel 1520. A solenoid 1240 or other type of actuator is mounted on the valve 1245 to operate the valve responsive to an electrical signal. The valve may be located in different positions. However, as explained above, the valve may preferably be located near, or even integral with, the base portion 1505 of the fitting 1305 to reduce the length of the beverage outlet channel 1520 and thereby reduce the amount of air introduced into the channel 1520 when the container is empty or removed.

Also shown in this view is a sensor 1525 mounted on the beverage outlet channel 1520 near the base portion 1505 of the fitting 1305 and between the base portion 1505 and the valve 1245. One or more sensor leads 1545 extend from the sensor 1525 to provide electrical connection to the sensor 1525. Via the sensor leads 1545, the sensor 1525 may be connected with a control, circuit for opening and closing the valve 1245 depending upon the presence or absence of beverage in the beverage outlet channel 1520 as detected by the sensor 1525. While the exact location of the sensor 1525 may vary, placing the sensor 1525 as close to the drain tube 1220 as is practical may be preferable in order to quickly detect when the container has become empty. Additionally, placing the sensor upstream of the valve allows the control circuit to detect the sensor signal and close the valve before a large amount of air enters the beverage outlet channel.

According to various embodiments of the present invention, various types of sensors may be used. For example, the sensor may be a photo-sensor that detects the presence of the beverage in the beverage outlet channel based on refraction of a light source mounted in the beverage outlet channel. In another example, the sensor may be an ultrasonic sensor that detects the presence of the beverage in the beverage outlet channel based on attenuation of an ultrasonic source mounted in the beverage outlet channel. In yet another example, the sensor may be a capacitive sensor that detects the presence of the beverage in the beverage outlet channel based on a change in a dielectric value of the capacitive sensor.

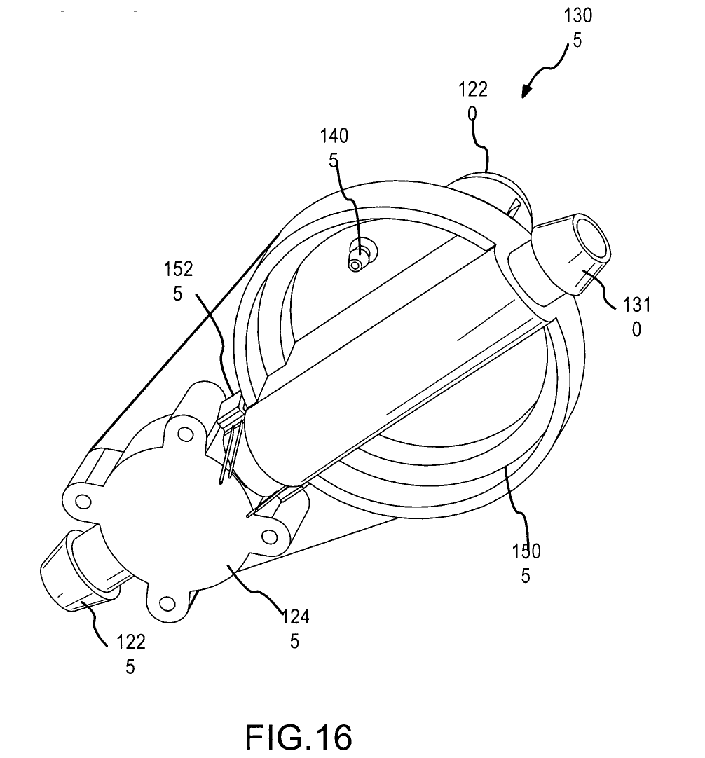

FIG. 16 is a bottom perspective view of the fitting for a mounting adapter of a beverage supply system illustrated in FIG. 15. As can be seen in this view, the base portion 1505 of the fitting 1305 may also include a funnel drain 1405. As explained above, the drain 1405 may be connected directly, or via tubing, to a drip pan or other drain external to the beverage supply system. This drain 1405 allows the draining of beverage that leaks from the container during installation or as the result of holes or cracks in the container. This way, leaked beverage does not accumulate in the body 1205 of the mounting adapter 1200 which reduces the transfer of harmful bacteria and mold from bottle to bottle when replenishing the system.

As shown in this example, the body of the valve 1245 and the base portion 1505 may be molded as a single piece. Additionally, the beverage outlet fitting 1225, air inlet fitting 1310, funnel drain 1405, and/or drain tube 1220 may also be molded as a single piece along with the base portion and valve body.

It will be clear that the present invention is well adapted to attain the ends and advantages mentioned as well as those inherent therein. While a presently preferred embodiment has been described for purposes of this disclosure, various changes and modifications may be made which are well within the scope of the present invention.

For example, the mounting adapter may be used with various types of pump fed or gravity fed beverage supply systems. As explained, various types of sensors and valve actuators may be used. Additionally, the exact location and configuration of the various parts of the mounting adapter may vary depending upon the implementation. Numerous other changes may be made which will readily suggest themselves to those skilled in the art and which are encompassed in the spirit of the invention disclosed and as defined in the appended claims.

What is claimed is:

1. A mounting adapter for a beverage dispensing system comprising:
a funnel-shaped body defining an opening at a base of the body and an opening at a top of the body wider than the opening at the base of the body and adapted to receive a beverage container having a bottom opening;
a fitting mounted in the opening at the base of the body, the fitting having a drain tube extending upwards into the body of the mounting adapter to penetrate and seal the bottom opening of the beverage container, the drain tube further having a beverage outlet channel and an air inlet channel, each of the channels separately extending through the drain tube and the fitting;
a sensor mounted on the beverage outlet channel near a base of the drain tube to detect a beverage within the beverage outlet channel; and
a valve mounted on the beverage outlet channel to close the beverage outlet channel in response to the sensor detecting that no beverage is present in the beverage outlet channel.

2. The mounting adapter of claim 1, further comprising a check valve coupled with the air inlet channel.

3. The mounting adapter of claim 2, further comprising a filter coupled with the check valve.

4. The mounting adapter of claim 3, wherein the filter is mounted in an opening in the body of the mounting adapter.

5. The mounting adapter of claim 1, wherein the sensor is a photo-sensor that detects the presence of the beverage in the beverage outlet channel based on refraction of a light source mounted in the beverage outlet channel.

6. The mounting adapter of claim 1, wherein the sensor is an ultrasonic sensor that detects the presence of the beverage in the beverage outlet channel based on attenuation of an ultrasonic source mounted in the beverage outlet channel.

7. The mounting adapter of claim 1, wherein the sensor is a capacitive sensor that detects the presence of the beverage in the beverage outlet channel based on a change in a dielectric value of the capacitive sensor.

8. The mounting adapter of claim 1, wherein the fitting further comprises a funnel drain.

9. The mounting adapter of claim 1, wherein a portion of the beverage outlet channel that extends through the fitting is angled downward relative to the drain tube.

10. The mounting adapter of claim 1, wherein the valve is a magnetic solenoid valve.

11. The mounting adapter of claim 1, wherein the fitting and the opening at the base of the body are threaded to secure the fitting to the body of the mounting adapter.

12. A fitting for a mounting adapter of a beverage dispensing system comprising:
a base portion adapted to be secured to a body of the mounting adapter;
a drain tube extending from the base portion to penetrate and seal the bottom opening of a beverage container, the drain tube further having a beverage outlet channel and an air inlet channel, each of the channels separately extending through the drain tube and the base portion of the fitting;
a sensor mounted on the beverage outlet channel near a base of the drain tube to detect a beverage within the beverage outlet channel; and
a valve mounted on the beverage outlet channel to close the beverage outlet channel in response to the sensor detecting that no beverage is present in the beverage outlet channel.

13. The fitting of claim 12, wherein the sensor is a photo-sensor that detects the presence of the beverage in the beverage outlet channel based on refraction of a light source mounted in the beverage outlet channel.

14. The fitting of claim 12, wherein the sensor is an ultrasonic sensor that detects the presence of the beverage in the beverage outlet channel based on attenuation of an ultrasonic source mounted in the beverage outlet channel.

15. The fitting of claim 12, wherein the sensor is a capacitive sensor that detects the presence of the beverage in the beverage outlet channel based on a change in a dielectric value of the capacitive sensor.

16. The fitting of claim 12, wherein the fitting further comprises a funnel drain.

17. The fitting of claim 12, wherein a portion of the beverage outlet channel that extends through the base portion of the fitting is angled downward relative to the drain tube.

18. The fitting of claim 12, wherein the valve is a magnetic solenoid valve.

19. The fitting of claim 12, wherein the base portion is threaded to secure the fitting to an opening in a body of the mounting adapter.
